(19) United States
(12) Patent Application Publication
(10) Pub. No.: US 2011/0122859 A1
(43) Pub. Date: May 26, 2011

(54) Method for Sending a Paging Message

(76) Inventors: Jianquan Song, Guangdong (CN); Xin Liu, Guangdong (CN); Li Chu, Guangdong (CN); Hongyun Qu, Guangdong (CN); Ling Xu, Guangdong (CN)

(21) Appl. No.: 13/054,654

(22) PCT Filed: Dec. 31, 2008
(86) PCT No.: PCT/CN2008/002161

§ 371 Date: Jan. 18, 2011

(30) Foreign Application Priority Data
Jul. 21, 2008 (CN) 200810134213.8

(51) Int. Cl. H04W 4/00

(52) U.S. Cl. 370/338

(57) ABSTRACT

The present invention discloses a method for sending a paging message applied to a Worldwide Interoperability for Microwave Access system, wherein an anchoring paging controller sends the paging message only to base stations meeting mobility restrictive conditions, or to base stations which belong to a paging group to which a terminal to be paged belongs and meet the mobility restrictive conditions; and the paging message is a paging starting message or a paging stopping message. Using the method in accordance with the present invention, the paging message can be prevented from sending to the base stations which do not meet the restrictive conditions of the terminal, thus reducing the consumption of the system resources.

### TECHNICAL FIELD

The present invention relates to the communication field, and in particular, to a method for sending a paging message in a WiMAX (Worldwide Interoperability for Microwave Access) system.

### BACKGROUND ART

An idle mode has been defined in a WiMAX system currently. When a terminal enters the idle mode from an activated mode, both its corresponding air connection and its connection with an access network are released, and information of the terminal is stored in an anchoring paging controller. Thus, the terminal will no occupy air resources and resources of the access network. The terminal entering the idle mode periodically receives downstream broadcasting messages, and is not required to be registered at a particular base station when moving between a plurality of base station areas, thus energy consumption of the terminal can be saved.

In the idle mode, the anchoring paging controller (each anchoring paging controller has a corresponding location register which is used to record information of the terminal in the idle mode) will send a paging message (a paging starting message) when any one of the following conditions is satisfied: there is data arriving at an anchoring data path in the access network; the network compels the terminal to perform location update; the network compels the terminal to perform network reentry.

Because base stations may perform paging for many times after the anchor paging controller sends the paging message (paging starting message) to a paging agent (located in the base station), when one of the base stations receives a response for the terminal and notifies the anchor paging controller, the anchoring paging controller is required to send the paging message (paging stopping message) to other base stations which have received the paging message (paging starting message) so as to cause these base stations to stop paging the terminal.

There are two types of paging starting message: one is a paging starting message sent by the anchoring paging controller to a local paging controller, which may reach the local paging controller via one or more relay paging controllers; the other is a paging starting message which is sent to the paging agent directly by the anchoring paging controller, or by the local paging controller. The first type of paging starting message may contain identifiers of base stations to be paged, while the second type of paging starting message is directly sent to the base stations without containing the identifiers of the base stations.

There are two types of paging stopping message as well: one is a paging stopping message sent by the anchoring paging controller to a local paging controller, which may reach the local paging controller via one or more relay paging controllers; the other is a paging stopping message which is sent to the paging agent directly by the anchoring paging controller, or by the local paging controller. Both types of paging stopping messages may not be required to contain the identifiers of the base stations.

FIG. 1 is a schematic diagram of a process where an anchoring paging controller sends a paging starting message in the existing WiMAX system. The process comprises the following steps.

101: An anchoring paging controller (each anchoring paging controller has a corresponding location register for recording information of a terminal in an idle mode) sends a paging starting message, which contains an identifier of a paging group to which the terminal belongs, to a local paging controller.

102: After receiving the paging starting message sent by the anchoring paging controller, the local paging controller sends the paging starting message to all base stations which belong to the paging group under the local paging controller.

It can be seen from the above description that mobility restriction characteristics of the terminal are not taken into consideration when the paging starting message or paging stopping message is sent in the existing WiMAX system. By mobility restriction is meant that the WiMAX system operator does not have a mobility license and is required to perform mobility restriction for its user terminals, or that even if the operator has a mobility license, however, in order to attract low end users to use the WiMAX network, the operator causes the users to use the WiMAX network at a low price under a condition of restricting mobility of such user terminals.

Since a paging group may include many base stations, the paging starting message or paging stopping message may be sent to a terminal access barred base station if the mobility restriction characteristics are not considered, greatly increasing consumption of communication resources of the system.

### SUMMARY OF THE INVENTION

The technical problem to be solved by the present invention is to overcome shortcomings of the prior art by providing a method for sending a paging message by referring to mobility restriction characteristics of a terminal in order to reduce consumption of communication resources.

The technical solution adopted by the present invention is a method for sending a paging message applied to a Worldwide Interoperability for Microwave Access system, wherein:

an anchoring paging controller sends the paging message only to base stations meeting mobility restrictive conditions, or to base stations which belong to a paging group to which a terminal to be paged belongs and meet the mobility restrictive conditions; and

the paging message is a paging starting message or a paging stopping message.

Further, the anchoring paging controller generates a list of paging area identifiers based on mobility restriction parameters of the terminal to be paged, wherein the list only contains identifiers of the base stations which meet the mobility restrictive conditions; or the anchoring paging controller generates a list of paging area identifiers based on an identifier of the paging group to which the terminal to be paged belongs and the mobility restriction parameters of the terminal, wherein the list only contains the identifiers of the base stations which belong to the paging group to which the terminal belongs and meet the mobility restrictive conditions;

the anchoring paging controller sends the paging message only to the base stations in the list of the paging area identifiers; or

the anchoring paging controller sends the paging message containing the list of the paging area identifiers to a local paging controller or to a local paging controller via a relay paging controller, and the local paging controller sends the paging message only to the base stations in the list of the paging area identifiers after receiving the paging message.

Further, the anchoring paging controller contains the mobility restriction parameters of the terminal into the paging message to send to the relay paging controller; after receiving the paging message, the relay paging controller generates the list of the paging area identifiers based on the mobility restriction parameters of the terminal and then sends the paging message containing the list of the paging area identifiers to the local paging controller, which, in turn, sends the paging message only to the base stations in the list of the paging area identifiers after receiving the paging message; or

the anchoring paging controller contains the identifier of the paging group of the terminal and the mobility restriction parameters of the terminal into the paging message to send to the relay paging controller; after receiving the paging message, the relay paging controller generates the list of the paging area identifiers based on the identifier of the paging group to which the terminal to be paged belongs and the mobility restriction parameters of the terminal and then sends the paging message containing the list of the paging area identifiers to the local paging controller, which, in turn, sends the paging message only to the base stations in the list of the paging area identifiers after receiving the paging message.

Further, the anchoring paging controller contains the mobility restriction parameters of the terminal into the paging message to send to the local paging controller or to the local paging controller via the relay paging controller, and the local paging controller generates the list of the paging area identifiers based on the mobility restriction parameters of the terminal and sends the paging message only to the base stations in the list of the paging area identifiers after receiving the paging message; or

the anchoring paging controller contains the identifier of the paging group of the terminal and the mobility restriction parameters of the terminal into the paging message to send to the local paging controller or to the local paging controller via the relay paging controller, and the local paging controller generates the list of the paging area identifiers based on the identifier of the paging group to which the terminal belongs and the mobility restriction parameters of the terminal and sends the paging message only to the base stations in the list of the paging area identifiers after receiving the paging message.

Further, the anchoring paging controller contains the mobility restriction parameters of the terminal into the paging message to send to the local paging controller or to the local paging controller via the relay paging controller, and the local paging controller sends the paging message only to the base stations which meet the mobility restrictive conditions after receiving the paging message; or

the anchoring paging controller contains the identifier of the paging group of the terminal and the mobility restriction parameters of the terminal into the paging message to send to the local paging controller or to the local paging controller via the relay paging controller, and the local paging controller sends the paging message only to the base stations which belong to the paging group to which the terminal to be paged belongs and meet the mobility restrictive conditions after receiving the paging message.

Further, if the mobility restriction parameters are a list of identifiers of access granted base stations or a list of identifiers of access granted network access provider, the meeting the mobility restrictive conditions means that the identifiers of the base stations belong to the list of the identifiers of the access granted base stations, or access networks, to which the base stations belong, belong to the list of the identifiers of the access granted network access provider.

If the mobility restriction parameters are a list of identifiers of access barred base stations or a list of identifiers of access barred network access provider, the meeting the mobility restrictive conditions means that the identifiers of the base stations do not belong to the list of the identifiers of the access barred base stations, or access networks, to which the base stations belong, do not belong to the list of the identifiers of the access barred network access provider.

Further, the anchoring paging controller stores the mobility restriction parameters of the terminal locally or sends a context request message to an anchoring authenticator and obtains the mobility restriction parameters of the terminal from a context response message returned by the anchoring authenticator.

Further, when the paging message is a paging stopping message, the anchoring paging controller sends the paging stopping message only to the base stations which meet the mobility restrictive conditions and have not received a response for the terminal, or the anchoring paging controller sends the paging stopping message only to the base stations that belong to the paging group to which the terminal to be paged belongs and meet the mobility restrictive conditions and have not received a response for the terminal.

Further, when the paging message is a paging stopping message, after generating the list of the paging area identifiers, the anchoring paging controller deletes the identifiers of the base stations which have received the response for the terminal from the list, and sends the paging stopping message only to the base stations in the list of the paging area identifiers, or sends the paging stopping message containing the list of the paging area identifiers to the local paging controller or to the local paging controller via the relay paging controller, and then the local paging controller sends the paging stopping message to the base stations in the list of the paging area identifiers.

Further, if the paging message sent to the relay paging controller by the anchoring paging controller is a paging stopping message, which contains the identifiers of the base stations which have received the response for the terminal, after generating the list of the paging area identifiers, the relay paging controller deletes the identifiers of the base stations which have received the response for the terminal from the list and sends the paging stopping message containing the list of the paging area identifiers to the local paging controller, which, in turn, sends the paging stopping message to the base stations in list of the paging area identifiers.

Further, when the paging message is a paging stopping message which contains the identifiers of the base stations which have received the response for the terminal, after generating the list of the paging area identifiers, the local paging controller deletes the identifiers of the base stations which have received the response for the terminal from the list and then sends the paging stopping message only to the base stations in the list of the paging area identifiers.

Further, if the paging message sent to the local paging controller or to the local paging controller via the relay paging controller by the anchoring paging controller is a paging stopping message which contains the mobility restriction parameters of the terminal and the identifiers of the base stations that have received the response for the terminal, after receiving the paging stopping message, the local paging controller sends the paging stopping message only to the base stations that meet the mobility restrictive conditions and have not received the response for the terminal.

If the paging message sent to the local paging controller or to the local paging controller via the relay paging controller by the anchoring paging controller is a paging stopping message which contains the identifier of the paging group to which the terminal belongs, the mobility restriction parameters of the terminal and the identifiers of the base stations that have received the response for the terminal, after receiving the paging stopping message, the local paging controller sends the paging stopping message only to the base stations which belong to the paging group to which the terminal to be paged belongs, meet the mobility restrictive conditions and have not received the response for the terminal.

To sum up, using the method in accordance with the present invention, the paging message can be prevented from sending to the base stations which do not meet the restrictive conditions of the terminal, thus reducing the consumption of the system resources. In addition, for the paging stopping message, the base stations that have received the response for the terminal are deleted from the list of the base stations in which the paging stopping message is to be sent, thus further reducing the consumption of the system resources.

### BRIEF DESCRIPTION OF DRAWINGS

FIG. 1 is a schematic diagram of a process where an anchoring paging controller sends a paging starting message in the existing WiMAX system;

FIG. 2 is a flow chart of a method for sending a paging message in accordance with the first embodiment of the present invention;

FIG. 3 is a flow chart of a method for sending a paging message in accordance with the second embodiment of the present invention;

FIG. 4 is a flow chart of a method for sending a paging message in accordance with the third embodiment of the present invention;

FIG. 5 is a flow chart of a method for sending a paging message in accordance with the fifth embodiment of the present invention; and

FIG. 6 is a flow chart of a method for an anchoring paging controller to obtain mobility restriction parameters of a terminal from an anchoring authenticator in accordance with an embodiment of the present invention.

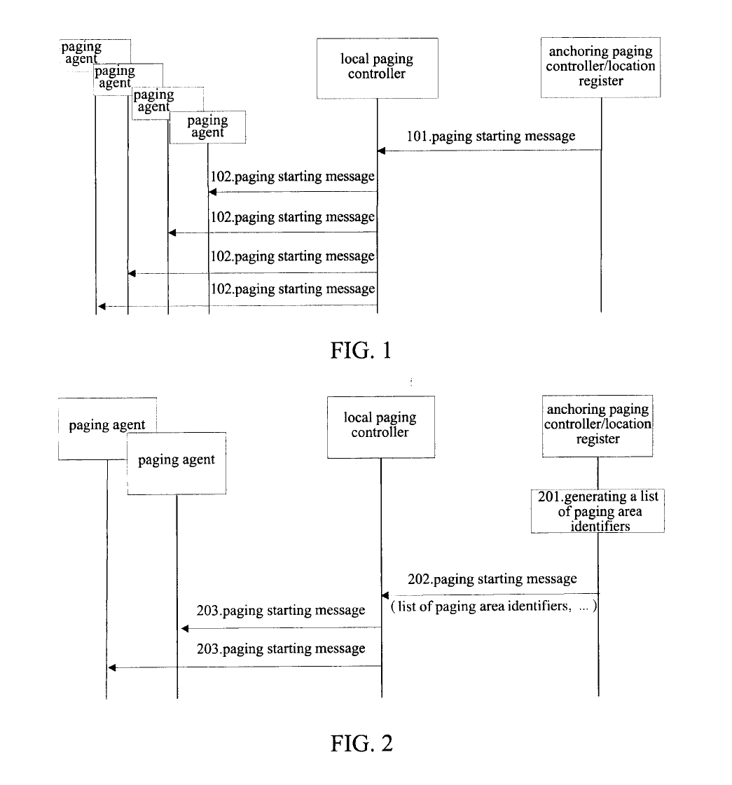

### PREFERRED EMBODIMENTS OF THE INVENTION

In a WiMAX system, mobility restriction parameters can be used to restrict mobility of a terminal. The mobility restriction parameters, including, but not limited to, some or all of the following parameters: MS mobility access type, access granted area (or access barred area), times of continuous handovers, handover granted minimum time interval, service base station reorientation granted or barred area, reorientation area service continuity support identifier, can be determined according to specific requirements of the operator.

Access granted/barred area may be a list of identifiers of access granted/barred base stations or a list of identifiers of access granted/barred network access provider.

Service base station reorientation means that when the load of a base station is too heavy or wireless environment is changed, a terminal is reoriented to another base station to continue to provide services for it. The reorientation area service continuity support identifier is used to indicate whether continuity of services is supported (i.e., the current services of the terminal are kept continuous) when the terminal is reoriented to a base station.

The present invention will be described in detail in conjunction with the accompanying drawings and embodiments.

### The First Embodiment

FIG. 2 is a flow chart of a method for sending a paging message in accordance with the first embodiment of the present invention. In this embodiment, mobility restriction parameters are stored in an anchoring paging controller, which sends a paging starting message to a paging agent (located in a base station) via a local paging controller. This method comprises the following steps.

201: The anchoring paging controller generates a list of paging area identifiers of a terminal, which contains only identifiers of base stations that meet the mobility restrictive conditions, based on the mobility restriction parameters of the terminal.

Further, the anchoring paging controller may also generate a list of paging area identifiers based on an identifier of a paging group to which the terminal belongs and the mobility restriction parameters of the terminal. The step comprises the following sub-steps.

201a: The anchoring paging controller obtains a list of identifiers of base stations or access networks included in the paging group to which the terminal belongs based on a network topology structure and the identifier of the paging group to which the terminal belongs.

201b: The anchoring paging controller generates the list of the identifiers of the base stations/access networks (collectively referred to as the list of the paging area identifiers of the terminal) meeting the mobility restrictive conditions of the terminal in the paging group to which the terminal belongs based on the list of the identifiers of the base stations or access networks and the mobility restriction parameters of the terminal by taking an intersection set of a set corresponding to the list of the identifiers of the base stations or the list of the identifiers of the access networks in the paging group to which the terminal belongs and a set corresponding to the list of the identifiers of the base stations or the list of the identifiers of the access networks which meet the mobility restrictive conditions.

For example, if the mobility restriction parameters are a list of identifiers of access granted base stations, the meeting the mobility restrictive conditions means that the identifiers of the base stations are in the list of the identifiers of the access granted network access provider.

If the mobility restriction parameters are a list of identifiers of access granted network access provider, the meeting the mobility restrictive conditions means that the identifiers of the access networks corresponding to the base stations are in the list of the identifiers of the access granted network access provider.

If the mobility restriction parameters are a list of identifiers of access barred base stations, the meeting the mobility restrictive conditions means that the identifiers of the base stations are not contained in the list of the identifiers of the access barred base stations.

If the mobility restriction parameters are a list of identifiers of access barred network access provider, the meeting the mobility restrictive conditions means that the identifiers of the access networks corresponding to the base stations are not in the list of the identifiers of the access barred network access provider.

202: The anchoring paging controller sends the paging starting message, which contains the list of the paging area identifiers, to the local paging controller; the anchoring paging controller may send the paging starting message to the local paging controller via one or more relay paging controllers.

203: After receiving the paging starting message, the local paging controller sends the paging starting message only to the base stations in the list of the paging area identifiers contained in the message according to the list.

It should be noted that a precondition for implementing the above embodiment is that the anchoring paging controller may know the topology structure of the network, i.e., know the situation of the relay paging controllers and base stations included in the paging group to which the terminal belongs and the belongingness between each base station and each relay paging controller.

If the topology structure of the network cannot be known, then the anchoring paging controller needs to send the mobility restriction parameters of the terminal or the identifier of the paging group to which the terminal belongs together with the mobility restriction parameters of the terminal to a next hop relay paging controller, which performs the above-described operation of generating the list of the paging area identifiers and sends the list to the local paging controller, which, in turn, sends the paging starting message to the base stations in the list. When there are one or more relay paging controllers, the above-described operation of generating the list of the paging area identifiers may be performed by any one of the relay paging controllers.

Of course, the anchoring paging controller can also send the mobility restriction parameters of the terminal or the identifier of the paging group to which the terminal belongs together with the mobility restriction parameters of the terminal to the local paging controller via the relay paging controller. Or when the next hop relay paging controller described above is the local paging controller, the anchoring paging controller can directly send the mobility restriction parameters of the terminal or the identifier of the paging group to which the terminal belongs together with the mobility restriction parameters of the terminal to the local paging controller, which may generate the list of the paging area identifiers of the terminal according to the method described in step 201 and then send the paging starting message to the base stations in the list after receiving the mobility restriction parameters of the terminal or the identifier of the paging group to which the terminal belongs and the mobility restriction parameters of the terminal. Instead of generating the list of the paging area identifiers, the local paging controller may directly send the paging starting message to the base stations meeting the mobility restrictive parameters according to the received mobility restrictive parameters of the terminal, or send the paging starting message to the base stations meeting the identifier of the paging group to which the terminal belongs and the mobility restriction parameters of the terminal according to the received identifier of the paging group to which the terminal belongs and the mobility restriction parameters of the terminal.

### The Second Embodiment

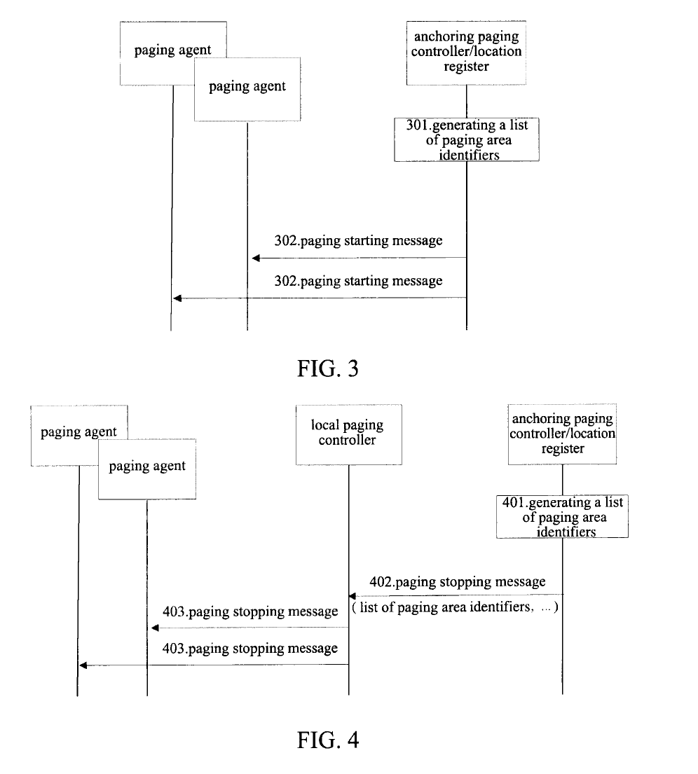

FIG. 3 is a flow chart of a method for sending a paging message in accordance with the second embodiment of the present invention. In this embodiment, mobility restriction parameters are stored in an anchoring paging controller, which sends a paging starting message to a paging agent (located in a base station) directly, instead of via a local paging controller/relay paging controller. This method comprises the following steps.

301: The anchoring paging controller generates a list of paging area identifiers of a terminal, which contains only identifiers of base stations that meet the mobility restrictive conditions, based on the mobility restriction parameters of the terminal.

Further, the anchoring paging controller may also generate a list of paging area identifiers based on an identifier of a paging group to which the terminal belongs and the mobility restriction parameters of the terminal. The step comprises the following sub-steps.

301a: The anchoring paging controller obtains a list of identifiers of base stations or access networks included in the paging group to which the terminal belongs based on a network topology structure and the identifier of the paging group to which the terminal belongs.

301b: The anchoring paging controller generates the list of the identifiers of the base station/access networks (collectively referred to as the list of the paging area identifiers of the terminal) meeting the mobility restrictive conditions of the terminal in the paging group to which the terminal belongs based on the list of the identifiers of the base stations or access networks and the mobility restriction parameters of the terminal by taking an intersection set of a set corresponding to the list of the identifiers of the base stations or the list of the identifiers of the access networks in the paging group to which the terminal belongs and a set corresponding to the list of the identifiers of the base stations or the list of the identifiers of the access networks which meet the mobility restrictive conditions.

For example, if the mobility restriction parameters are a list of identifiers of access granted base stations, the meeting the mobility restrictive conditions means that the identifiers of the base stations are in the list of the identifiers of the access granted network access provider.

If the mobility restriction parameters are a list of identifiers of access granted network access provider, the meeting the mobility restrictive conditions means that the identifiers of the access networks corresponding to the base stations are in the list of the identifiers of the access granted network access provider.

If the mobility restriction parameters are a list of identifiers of access barred base stations, the meeting the mobility restrictive conditions means that the identifiers of the base stations are not contained in the list of the identifiers of the access barred base stations.

If the mobility restriction parameters are a list of identifiers of access barred network access provider, the meeting the mobility restrictive conditions means that the identifiers of the access networks corresponding to the base stations are not in the list of the identifiers of the access barred network access provider.

302: The local paging controller sends the paging starting message only to the base stations in the list of the paging area identifiers according to the list.

Of course, in this embodiment, instead of generating the list of the paging area identifiers, the anchoring paging controller may directly send the paging starting message to the base stations meeting the mobility restrictive parameters according to the stored mobility restrictive parameters of the terminal, or send the paging starting message to the base stations meeting the identifier of the paging group to which the terminal belongs and the mobility restriction parameters of the terminal according to the stored identifier of the paging group to which the terminal belongs and the mobility restriction parameters of the terminal.

It should be noted that since the anchoring paging controller is the local paging controller of the terminal in this embodiment, the anchoring paging controller may know the topology structure of the network, i.e., know the list of the identifiers of the base stations/access networks corresponding to the paging group to which the terminal belongs.

### The Third Embodiment

FIG. 4 is a flow chart of a method for sending a paging message in accordance with the third embodiment of the present invention. In this embodiment, mobility restriction parameters are stored in an anchoring paging controller, which sends a paging stopping message to a paging agent (located in a base station) via a local paging controller. This method comprises the following steps.

401: The anchoring paging controller generates a list of paging area identifiers of a terminal, which contains only identifiers of base stations that meet the mobility restrictive conditions, based on the mobility restriction parameters of the terminal.

Further, the anchoring paging controller may also generate a list of paging area identifiers based on an identifier of a paging group to which the terminal belongs and the mobility restriction parameters of the terminal. The step comprises the following sub-steps.

401a: The anchoring paging controller obtains a list of identifiers of base stations or access networks included in the paging group to which the terminal belongs based on a network topology structure and the identifier of the paging group to which the terminal belongs.

401b: The anchoring paging controller generates the list of the identifiers of the base station/access networks (collectively referred to as the list of the paging area identifiers of the terminal) meeting the mobility restrictive conditions of the terminal in the paging group to which the terminal belongs based on the list of the identifiers of the base stations or access networks and the mobility restriction parameters of the terminal by taking an intersection set of a set corresponding to the list of the identifiers of the base stations or the list of the identifiers of the access networks in the paging group to which the terminal belongs and a set corresponding to the list of the identifiers of the base stations or the list of the identifiers of the access networks which meet the mobility restrictive conditions.

For example, if the mobility restriction parameters are a list of identifiers of access granted base stations, the meeting the mobility restrictive conditions means that the identifiers of the base stations are in the list of the identifiers of the access granted network access provider.

If the mobility restriction parameters are a list of identifiers of access granted network access provider, the meeting the mobility restrictive conditions means that the identifiers of the access networks corresponding to the base stations are in the list of the identifiers of the access granted network access provider.

If the mobility restriction parameters are a list of identifiers of access barred base stations, the meeting the mobility restrictive conditions means that the identifiers of the base stations are not contained in the list of the identifiers of the access barred base stations.

If the mobility restriction parameters are a list of identifiers of access barred network access provider, the meeting the mobility restrictive conditions means that the identifiers of the access networks corresponding to the base stations are not in the list of the identifiers of the access barred network access provider.

Additionally, since a base station which has received a response for the terminal will automatically stop paging, the base station can be deleted from the list of the paging area identifiers of the terminal to avoid sending the paging stopping message to the base station in order to further reduce consumption of communication resources of the system.

402: The anchoring paging controller sends the paging stopping message, which contains the list of the paging area identifiers, to the local paging controller; the anchoring paging controller may send the paging starting message to the local paging controller via one or more relay paging controllers.

403: After receiving the paging stopping message, the local paging controller sends the paging stopping message only to the base stations in the list of the paging area identifiers contained in the message according to the list.

It should be noted that a precondition for implementing the above embodiment is that the anchoring paging controller may know the topology structure of the network, i.e., know the situation of the relay paging controllers and base stations included in the paging group to which the terminal belongs and the belongingness between each base station and each relay paging controller.

If the topology structure of the network cannot be known, then the anchoring paging controller needs to send the mobility restriction parameters of the terminal or the identifier of the paging group to which the terminal belongs together with the mobility restriction parameters of the terminal to a next hop relay paging controller, which performs the above-described operation of generating the list of the paging area identifiers, and then contain the list of the paging area identifiers into the paging stopping message to send to the local paging controller. Further, if the anchoring paging controller sends the identifiers of the base stations which have received the response for the terminal to the relay paging controller, the relay paging controller may further delete the identifiers of the base stations which have received the response for the terminal from the list of the paging area identifiers and then contain the list of the paging area identifiers into the paging stopping message to send to the local paging controller, which, in turn, sends the paging stopping message only to the base stations in the list.

Of course, the anchoring paging controller can also send the mobility restriction parameters of the terminal together with the identifiers of the base stations which have received the response for the terminal or the identifier of the paging group to which the terminal belongs together with the mobility restriction parameters of the terminal and the identifiers of the base stations which have received the response for the terminal to the local paging controller via the relay paging controller. Or when the next hop relay paging controller described above is the local paging controller, the anchoring paging controller can directly send the mobility restriction parameters of the terminal together with the identifiers of the base stations which have received the response for the terminal or the identifier of the paging group to which the terminal belongs together with the mobility restriction parameters of the terminal and the identifiers of the base stations which have received the response for the terminal to the local paging controller, which may generate the list of the paging area identifiers of the terminal according to the method described in step 101 and send the paging stopping message to the base stations in the list after receiving the identifier of the paging group to which the terminal belongs together with the mobility restriction parameters of the terminal and the identifiers of the base stations which have received the response for terminal. Instead of generating the list of the paging area identifiers, the local paging controller may directly send the paging stopping message to the base stations meeting the mobility restrictive parameters according to the received mobility restrictive parameters of the terminal, or send the paging stopping message to the base stations meeting the identifier of the paging group to which the terminal belongs and the mobility restriction parameters of the terminal according to the received identifier of the paging group to which the terminal belongs and the mobility restriction parameters of the terminal. Further, the local paging controller may also send the paging stopping message only to the base stations which meet the mobility restrictive parameters but have not received the response for the terminal or to the base stations which belong to the paging group to which the terminal to be paged belongs, meet the mobility restrictive parameters but have not received the response for the terminal.

### The Fourth Embodiment

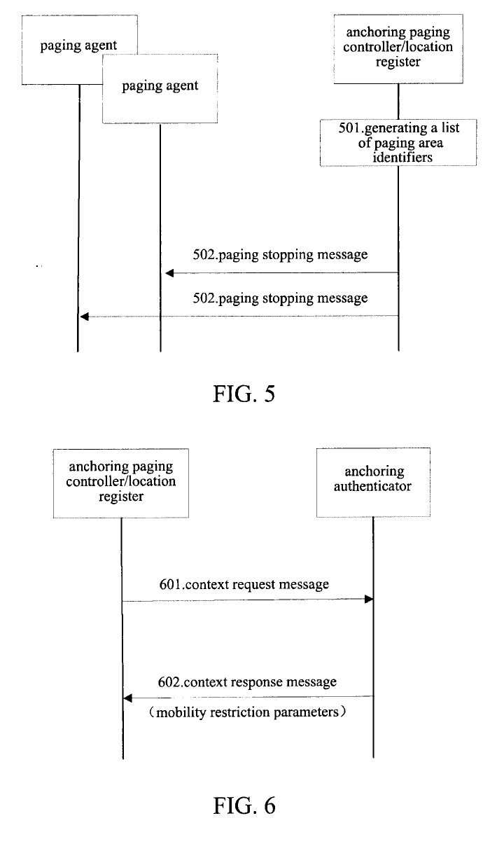

FIG. 5 is a flow chart of a method for sending a paging message in accordance with the fourth embodiment of the present invention. In this embodiment, mobility restriction parameters are stored in an anchoring paging controller, which sends a paging stopping message to a paging agent (located in a base station) directly, instead of via a local paging controller/relay paging controller. This method comprises the following steps.

501: The anchoring paging controller generates a list of paging area identifiers of a terminal, which contains only identifiers of base stations that meet the mobility restrictive conditions, based on the mobility restriction parameters of the terminal.

Further, the anchoring paging controller may also generate a list of paging area identifiers based on an identifier of a paging group to which the terminal belongs and the mobility restriction parameters of the terminal. The step comprises the following sub-steps.

501a: The anchoring paging controller obtains a list of identifiers of base stations or access networks included in the paging group to which the terminal belongs based on a network topology structure and the identifier of the paging group to which the terminal belongs.

501b: The anchoring paging controller generates the list of the identifiers of the base station/access networks (collectively referred to as the list of the paging area identifiers of the terminal) meeting the mobility restrictive conditions of the terminal in the paging group to which the terminal belongs based on the list of the identifiers of the base stations or access networks and the mobility restriction parameters of the terminal by taking an intersection set of a set corresponding to the list of the identifiers of the base stations or the list of the identifiers of the access networks in the paging group to which the terminal belongs and a set corresponding to the list of the identifiers of the base stations or the list of the identifiers of the access networks which meet the mobility restrictive conditions.

For example, if the mobility restriction parameters are a list of identifiers of access granted base stations, the meeting the mobility restrictive conditions means that the identifiers of the base stations are in the list of the identifiers of the access granted network access provider.

If the mobility restriction parameters are a list of identifiers of access granted network access provider, the meeting the mobility restrictive conditions means that the identifiers of the access networks corresponding to the base stations are in the list of the identifiers of the access granted network access provider.

If the mobility restriction parameters are a list of identifiers of access barred base stations, the meeting the mobility restrictive conditions means that the identifiers of the base stations are not contained in the list of the identifiers of the access barred base stations.

If the mobility restriction parameters are a list of identifiers of access barred network access provider, the meeting the mobility restrictive conditions means that the identifiers of the access networks corresponding to the base stations are not in the list of the identifiers of the access barred network access provider.

Additionally, since a base station which has received a response for the terminal will automatically stop paging, the base station can be deleted from the list of the paging area identifiers of the terminal to avoid sending the paging stopping message to the base station in order to further reduce consumption of communication resources of the system.

502: The local paging controller sends the paging stopping message only to the base stations in the list of the paging area identifiers according to the list.

Of course, in this embodiment, instead of generating the list of the paging area identifiers, the anchoring paging controller may directly send the paging stopping message to the base stations meeting the mobility restrictive parameters according to the stored mobility restrictive parameters of the terminal, or send the paging stopping message to the base stations meeting the identifier of the paging group to which the terminal belongs and the mobility restriction parameters of the terminal according to the stored identifier of the paging group to which the terminal belongs and the mobility restriction parameters of the terminal. Further, the local paging controller may also send the paging stopping message only to the base stations which meet the mobility restrictive parameters but have not received the response for the terminal or to the base stations which belong to the paging group to which the terminal to be paged belongs, meet the mobility restrictive parameters but have not received the response for the terminal.

In each of the above embodiments, the mobility restriction parameters are stored in the anchoring paging controller. If the mobility restriction parameters are stored in an anchoring authenticator, then the anchoring paging controller is firstly required to obtain the mobility restriction parameters of the terminal from the anchoring authenticator through message interaction. FIG. 6 is a flow chart of a method for an anchoring paging controller to obtain mobility restriction parameters of terminal from an anchoring authenticator in accordance with an embodiment of the present invention. The method comprises the following steps.

601: The anchoring paging controller sends a context request message, which contains a list of identifiers of terminals to be paged and a list of identifiers of terminal access granted areas or a list of identifiers of access barred areas or indication information regarding all of the mobility restriction parameters, to the anchoring authenticator.

602: The anchoring authenticator sends a context response message, which contains a list of identifiers of terminals and a list of identifiers of terminal access granted areas or a list of identifiers of access barred areas or all of the mobility restriction parameters, to the anchoring paging controller.

Of course, many other embodiments in accordance with the present invention may be used. Various corresponding modifications and variations may be made by those skilled in the art according to the present invention without departing from the spirit and essence of the present invention. However, all of these corresponding modifications and variations should fall within the protection scope defined by the appended claim.

### INDUSTRIAL APPLICABILITY

Using the method in accordance with the present invention, the paging message can be prevented from sending to the base stations which do not meet the restrictive conditions of the terminal, thus reducing the consumption of the system resources. In addition, for the paging stopping message, the base stations that have received the response for the terminal are deleted from the list of the base stations in which the paging stopping message is to be sent, thus further reducing the consumption of the system resources.

What we claim is:

1. A method for sending a paging message applied to a Worldwide Interoperability for Microwave Access system, wherein:
an anchoring paging controller sends the paging message only to base stations meeting mobility restrictive conditions, or to base stations which belong to a paging group to which a terminal to be paged belongs and meet the mobility restrictive conditions; and
the paging message is a paging starting message or a paging stopping message.

2. The method according to claim 1, wherein:
the anchoring paging controller generates a list of paging area identifiers based on mobility restriction parameters of the terminal to be paged, wherein the list only contains identifiers of the base stations which meet the mobility restrictive conditions; or the anchoring paging controller generates a list of paging area identifiers based on an identifier of the paging group to which the terminal to be paged belongs and the mobility restriction parameters of the terminal, wherein the list only contains the identifiers of the base stations which belong to the paging group to which the terminal belongs and meet the mobility restrictive conditions; and
the anchoring paging controller sends the paging message only to the base stations in the list of the paging area identifiers; or
the anchoring paging controller sends the paging message containing the list of the paging area identifiers to a local paging controller or to a local paging controller via a relay paging controller, and the local paging controller sends the paging message only to the base stations in the list of the paging area identifiers after receiving the paging message.

3. The method according to claim 1, wherein:
the anchoring paging controller contains the mobility restriction parameters of the terminal into the paging message to send to the relay paging controller; after receiving the paging message, the relay paging controller generates the list of the paging area identifiers based on the mobility restriction parameters of the terminal and then sends the paging message containing the list of the paging area identifiers to the local paging controller, which, in turn, sends the paging message only to the base stations in the list of the paging area identifiers after receiving the paging message; or
the anchoring paging controller contains the identifier of the paging group of the terminal and the mobility restriction parameters of the terminal into the paging message to send to the relay paging controller; after receiving the paging message, the relay paging controller generates the list of the paging area identifiers based on the identifier of the paging group to which the terminal to be paged belongs and the mobility restriction parameters of the terminal and then sends the paging message containing the list of the paging area identifiers to the local paging controller, which, in turn, sends the paging message only to the base stations in the list of the paging area identifiers after receiving the paging message.

4. The method according to claim 1, wherein:
the anchoring paging controller contains the mobility restriction parameters of the terminal into the paging message to send to the local paging controller or to the local paging controller via the relay paging controller, and the local paging controller generates the list of the paging area identifiers based on the mobility restriction parameters of the terminal and sends the paging message only to the base stations in the list of the paging area identifiers after receiving the paging message; or
the anchoring paging controller contains the identifier of the paging group of the terminal and the mobility restriction parameters of the terminal into the paging message to send to the local paging controller or to the local paging controller via the relay paging controller, and the local paging controller generates the list of the paging area identifiers based on the identifier of the paging group to which the terminal belongs and the mobility restriction parameters of the terminal and sends the paging message only to the base stations in the list of the paging area identifiers after receiving the paging message.

5. The method according to claim 1, wherein:
the anchoring paging controller contains the mobility restriction parameters of the terminal into the paging message to send to the local paging controller or to the local paging controller via the relay paging controller, and the local paging controller sends the paging message only to the base stations which meet the mobility restrictive conditions after receiving the paging message; or
the anchoring paging controller contains the identifier of the paging group of the terminal and the mobility restriction parameters of the terminal into the paging message to send to the local paging controller or to the local paging controller via the relay paging controller, and the local paging controller sends the paging message only to the base stations which belong to the paging group to which the terminal to be paged belongs and meet the mobility restrictive conditions after receiving the paging message.

6. The method according to claim 2, wherein:
if the mobility restriction parameters are a list of identifiers of access granted base stations or a list of identifiers of access granted network access provider, the meeting the mobility restrictive conditions means that the identifiers of the base stations belong to the list of the identifiers of the access granted base stations, or access networks, to which the base stations belong, belong to the list of the identifiers of the access granted network access provider; and
if the mobility restriction parameters are a list of identifiers of access barred base stations or a list of identifiers of access barred network access provider, the meeting the mobility restrictive conditions means that the identifiers of the base stations do not belong to the list of the identifiers of the access barred base stations, or access networks, to which the base stations belong, do not belong to the list of the identifiers of the access barred network access provider.

7. The method according to claim 2, wherein:
the anchoring paging controller stores the mobility restriction parameters of the terminal locally or sends a context request message to an anchoring authenticator and obtains the mobility restriction parameters of the terminal from a context response message returned by the anchoring authenticator.

8. The method according to claim 1, wherein:
when the paging message is a paging stopping message, the anchoring paging controller sends the paging stopping message only to the base stations which meet the mobility restrictive conditions and have not received a response for the terminal, or the anchoring paging controller sends the paging stopping message only to the base stations that belong to the paging group to which the terminal to be paged belongs and meet the mobility restrictive conditions and have not received a response for the terminal.

9. The method according to claim 2, wherein:
when the paging message is a paging stopping message, after generating the list of the paging area identifiers, the anchoring paging controller deletes the identifiers of the base stations which have received the response for the terminal from the list, and sends the paging stopping message only to the base stations in the list of the paging area identifiers, or sends the paging stopping message containing the list of the paging area identifiers to the local paging controller or to the local paging controller via the relay paging controller, and wherein the local paging controller sends the paging stopping message to the base stations in the list of the paging area identifiers.

10. The method according to claim 3, wherein:
if the paging message sent to the relay paging controller by the anchoring paging controller is a paging stopping message, which contains the identifiers of the base stations which have received the response for the terminal, after generating the list of the paging area identifiers, the relay paging controller deletes the identifiers of the base stations which have received the response for the terminal from the list and sends the paging stopping message containing the list of the paging area identifiers to the local paging controller, which, in turn, sends the paging stopping message to the base stations in list of the paging area identifiers.

11. The method according to claim 4, wherein:
when the paging message is a paging stopping message which contains the identifiers of the base stations which have received the response for the terminal, after generating the list of the paging area identifiers, the local paging controller deletes the identifiers of the base stations which have received the response for the terminal from the list and then sends the paging stopping message only to the base stations in the list of the paging area identifiers.

12. The method according to claim 1, wherein:
if the paging message sent to the local paging controller or to the local paging controller via the relay paging controller by the anchoring paging controller is a paging stopping message which contains the mobility restriction parameters of the terminal and the identifiers of the base stations that have received the response for the terminal, after receiving the paging stopping message, the local paging controller sends the paging stopping message only to the base stations that meet the mobility restrictive conditions and have not received the response for the terminal; and
if the paging message sent to the local paging controller or to the local paging controller via the relay paging controller by the anchoring paging controller is a paging stopping message which contains the identifier of the paging group to which the terminal belongs, the mobility restriction parameters of the terminal and the identifiers of the base stations that have received the response for the terminal, after receiving the paging stopping message, the local paging controller sends the paging stopping message only to the base stations which belong to the paging group to which the terminal to be paged belongs, meet the mobility restrictive conditions and have not received the response for the terminal.

13. The method according to claim 3, wherein:
if the mobility restriction parameters are a list of identifiers of access granted base stations or a list of identifiers of access granted network access provider, the meeting the mobility restrictive conditions means that the identifiers of the base stations belong to the list of the identifiers of the access granted base stations, or access networks, to which the base stations belong, belong to the list of the identifiers of the access granted network access provider; and
if the mobility restriction parameters are a list of identifiers of access barred base stations or a list of identifiers of access barred network access provider, the meeting the mobility restrictive conditions means that the identifiers of the base stations do not belong to the list of the identifiers of the access barred base stations, or access networks. to which the base stations belong, do not belong to the list of the identifiers of the access barred network access provider.

14. The method according to claim 4, wherein:
if the mobility restriction parameters are a list of identifiers of access granted base stations or a list of identifiers of access granted network access provider, the meeting the mobility restrictive conditions means that the identifiers of the base stations belong to the list of the identifiers of the access granted base stations, or access networks, to which the base stations belong, belong to the list of the identifiers of the access granted network access provider; and
if the mobility restriction parameters are a list of identifiers of access barred base stations or a list of identifiers of access barred network access provider, the meeting the mobility restrictive conditions means that the identifiers of the base stations do not belong to the list of the identifiers of the access barred base stations, or access networks, to which the base stations belong, do not belong to the list of the identifiers of the access barred network access provider.

15. The method according to claim 5, wherein:
if the mobility restriction parameters are a list of identifiers of access granted base stations of a list of identifiers of access granted network access provider, the meeting the mobility restrictive conditions means that the identifiers of the base stations belong to the list of the identifiers of the access granted base stations, or access networks, to which the base stations belong, belong to the list of the identifiers of the access granted network access provider: and
if the mobility restriction parameters are a list of identifiers of access barred base stations or a list of identifiers of access barred network access provider, the meeting the mobility restrictive conditions means that the identifiers of the base stations do not belong to the list of the identifiers of the access barred base stations, or access networks, to which the base stations belong, do not belong to the list of the identifiers of the access barred network access provider.

16. The method according to claim 3, wherein:
the anchoring paging controller stores the mobility restriction parameters of the terminal locally or sends a context request message to an anchoring authenticator and obtains the mobility restriction parameters of the terminal from a context response message returned by the anchoring authenticator.

17. The method according to claim 4, wherein:
the anchoring paging controller stores the mobility restriction parameters of the terminal locally or sends a context request message to an anchoring authenticator and obtains the mobility restriction parameters of the terminal from a context response message returned by the anchoring authenticator.

18. The method according to claim 5, wherein:
the anchoring paging controller stores the mobility restriction parameters of the terminal locally or sends a context request message to an anchoring authenticator and obtains the mobility restriction parameters of the terminal from a context response message returned by the anchoring authenticator.
